(19) United States
(12) Patent Application Publication
(10) Pub. No.: US 2004/0176144 A1
(43) Pub. Date: Sep. 9, 2004

(54) Signal changeable blue tooth earphone device

(76) Inventor: Mark Tung, Hsin Chuang City (TW)

Correspondence Address: Mark Tung, P. O. Box 4-67, Hsin Chuang, Taipei, 242, TW

(21) Appl. No.: 10/367,394

(22) Filed: Feb. 11, 2003

(51) Int. Cl. H04M 1/00

(52) U.S. Cl. 455/569.1; 455/574

(57) ABSTRACT

A blue tooth earphone device includes a control facility having a setting device coupled to a processor device to set selected codes, a mating device coupled to the processor device, and a wireless signal communicating device coupled to the processor device for wireless communicating purposes. A key device is coupled to the processor device to control the processor device, and a blue tooth device is coupled to the communicating device to wirelessly communicate the processor device with other blue tooth facilities. The mating device may select either of the set codes, to changeably communicate with various blue tooth phone or earphone facilities.

### BACKGROUND OF THE INVENTION

1. Field of the Invention

The present invention relates to an earphone device, and more particularly to a blue tooth earphone device changeable to different codes or signals to receive phones from various selected or different phone devices or systems.

2. Description of the Prior Art

Typical earphone devices are cable connectable to electrical facilities or phone systems, to receive phones. It is to be noted that the typical earphone devices may be used to receive phones only, and may not be switched or controlled or changed to conduct other operations.

Several typical wireless earphone devices have been developed for allowing the users to receive phones wirelessly. However, similarly, the typical wireless earphone devices may also be used to receive phones from a predetermined or selected phone device only, and may not be switched or controlled or changed to receive phones from the other or different phone devices

For example, when the users possess two or more phone devices having different operating codes or signals, the users have to prepare two or more earphone devices having different operating codes or signals corresponding to that of the phone devices, in order to receive the phones from the phone devices respectively. The earphone devices may not be used to receive the phones from the phone devices having different operating codes or signals; i.e., the typical phone devices each includes a predetermined operating code or signal to mate and to receive the phones from the predetermined or selected phone device that has the corresponding operating code or signal of that of the predetermined or selected phone device.

The present invention has arisen to mitigate and/or obviate the afore-described disadvantages of the conventional earphone devices.

### SUMMARY OF THE INVENTION

The primary objective of the present invention is to provide a blue tooth earphone device that is changeable or switchable to different codes or signals in order to receive phones from various selected or different phone devices or systems.

In accordance with one aspect of the invention, there is provided a blue tooth earphone device comprising a control facility including a processor device, a setting device coupled to the processor device, to set selected codes, a mating device coupled to the processor device, to select either of the set codes, a wireless signal communicating device coupled to the processor device, for wireless communicating purposes, a key device coupled to the processor device of the control facility, to control the processor device of the control facility, and a blue tooth device coupled to the wireless signal communicating device of the control facility, to wireless communicate the processor device of the control facility to other blue tooth facilities. The setting device may be used to set one or more selected codes, and a mating device may be used to select either of the set codes, for allowing the earphone device to be changeably communicated with various selected blue tooth phone or earphone facilities, with the wireless signal communicating device and/or the blue tooth device.

The control facility may further include an electricity economizing device coupled to the processor device thereof, to economize electric energy supplied to the control facility, and/or a signal display device coupled to the processor device thereof, to generate signals.

The earphone device may further include a light device coupled to the signal display device of the control facility, to generate light signals when required.

The control facility may further include a sound generating device coupled to the processor device thereof, to generate sound signals, and/or a resetting device coupled to the processor device thereof, to reset the processor device of the control facility.

The key device may include a key to increase volume of the earphone device, and/or another key to decrease volume of the earphone device, and/or a further key to generate a phone receiving signal, and/or a still further key to generate a resetting signal.

Further objectives and advantages of the present invention will become apparent from a careful reading of the detailed description provided herein below, with appropriate reference to the accompanying drawings.

### BRIEF DESCRIPTION OF THE DRAWINGS

FIG. 1 is a plan schematic view of a blue tooth earphone device in accordance with the present invention;

FIG. 2 is a block diagram illustrating the code setting operation processes or elements or members of the blue tooth earphone device;

FIG. 3 is a block diagram illustrating the code or signal switching operation processes or elements or members of the blue tooth earphone device;

FIG. 4 is a block diagram illustrating the electricity saving operation processes or elements or members of the blue tooth earphone device; and

FIG. 5 is a block diagram illustrating the phones freely receiving processes or elements or members of the blue tooth earphone device.

### DETAILED DESCRIPTION OF THE PREFERRED EMBODIMENT

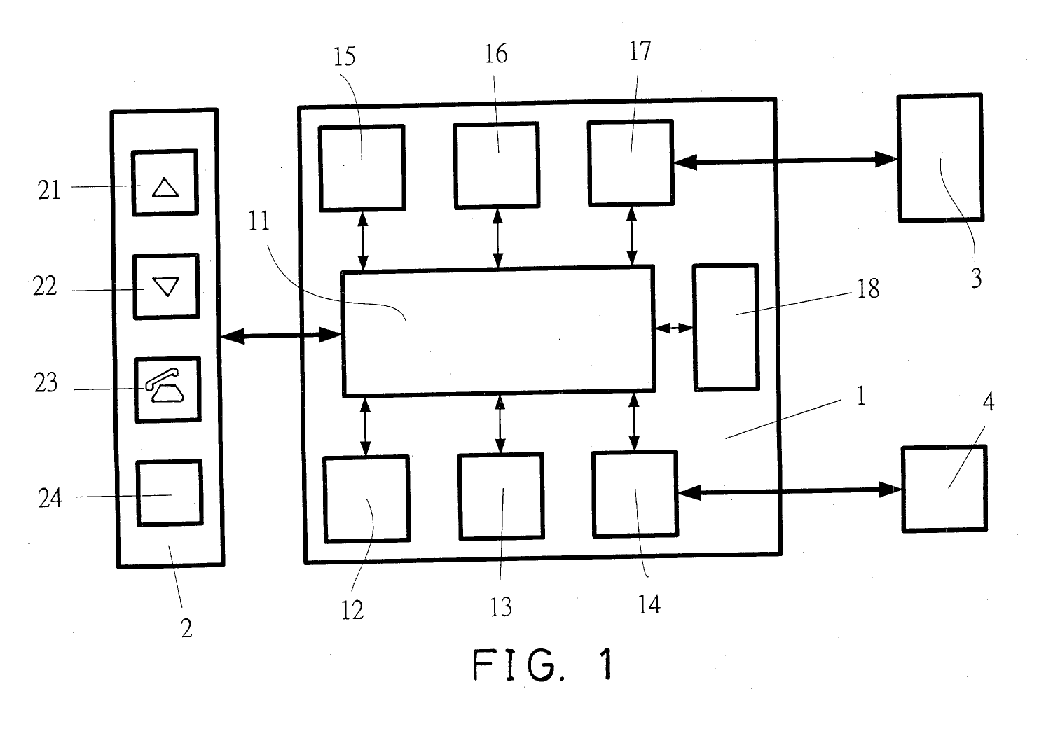

Referring to the drawings, and initially to FIG. 1, a blue tooth earphone device in accordance with the present invention comprises a control chip or integrated circuit or facility 1 including a key control or processor unit or device 11 disposed therein for controlling or processing signals or codes or the like of the blue tooth earphone device.

A key unit or device 2 is coupled to the control facility 1, such as coupled to the processor device 11 of the control facility 1, in order to control the processor device 11 of the control facility 1. For example, the key device 2 includes a button or key 21 for increasing the volume of the earphone device, another button or key 22 for decreasing the volume of the earphone device, a further button or key 23 for picking up or for receiving the phone or for generating a phone receiving signal, and a still further button or key 24 for resetting purposes or for generating a resetting signal.

In operation, when either of the keys 21-24 is depressed or actuated, one or more control or key signals may be sent to the processor device 11 of the control facility 1, in order to increase or decrease the volume of the earphone device, or to pick up or receive phones, or to reset the processor device 11 of the control facility 1. The other keys (not shown) may further be provided to send control signals or to control the processor device 11 of the control facility 1.

The control facility 1 includes a setting unit or circuit or device 12 coupled to the processor device 11, in order to initialize or to start or to operate the processor device 11 of the control facility 1, or to record or set or store the codes or frequencies or signals of the selected blue tooth earphone devices or blue tooth phone devices; and includes an electricity economizing or saving unit or circuit or device 13 coupled to the processor device 11, in order to save or economize the electrical energy supplied to the processor device 11 of the control facility 1, particularly when the earphone device is not in use or is in a non-working mode or status.

The control facility 1 further includes a signal display unit or circuit or device 14 coupled to the processor device 11 of the control facility 1, in order to generate light or various signals when required. For example, a light device 4 is coupled to the signal display device 14, and controlled by the signal display device 14, in order to generate the light signals, so as to show or display the operations or status of the keys 21-24 or of the members or elements of the control facility 1.

A buzzer or ring or sound generating or controlling unit or circuit or device 18 may further be provided and coupled to the processor device 11 of the control facility 1, in order to generate sound or ring signals when required. For example, the sound generating device 18 may generate rings or sounds to show or to indicate the incoming phone calls.

The control facility 1 further includes a resetting unit or circuit or device 15 coupled to the processor device 11, in order to reset or to restart the processor device 11 of the control facility 1, or to clean the previously set signals or codes in the processor device 11 of the control facility 1. The control facility 1 includes a mating unit or circuit or device 16 coupled to the processor device 11, in order to mate or couple or communicate the processor device 11 of the control facility 1 with various blue tooth earphone devices and/or various blue tooth phone devices.

The control facility 1 includes a wireless signal transmitting or communicating unit or circuit or device 17 coupled to the processor device 11 of the control facility 1. A blue tooth interface card or module or device 3 is coupled to the wireless signal communicating device 17, for transmitting or receiving or communicating wireless signals between the control facility 1 of the earphone device and the other blue tooth phone devices.

In operation, the users may dial phones or transmit signals to the other blue tooth earphone devices or blue tooth phone devices, with the blue tooth device 3 and the wireless signal communicating device 17 and the processor device 11 of the control facility 1 of the blue tooth earphone device in accordance with the present invention; and may also receive phones or signals from the other blue tooth earphone devices or blue tooth phone devices, with the blue tooth device 3 and the wireless signal communicating device 17 and the processor device 11 of the control facility 1.

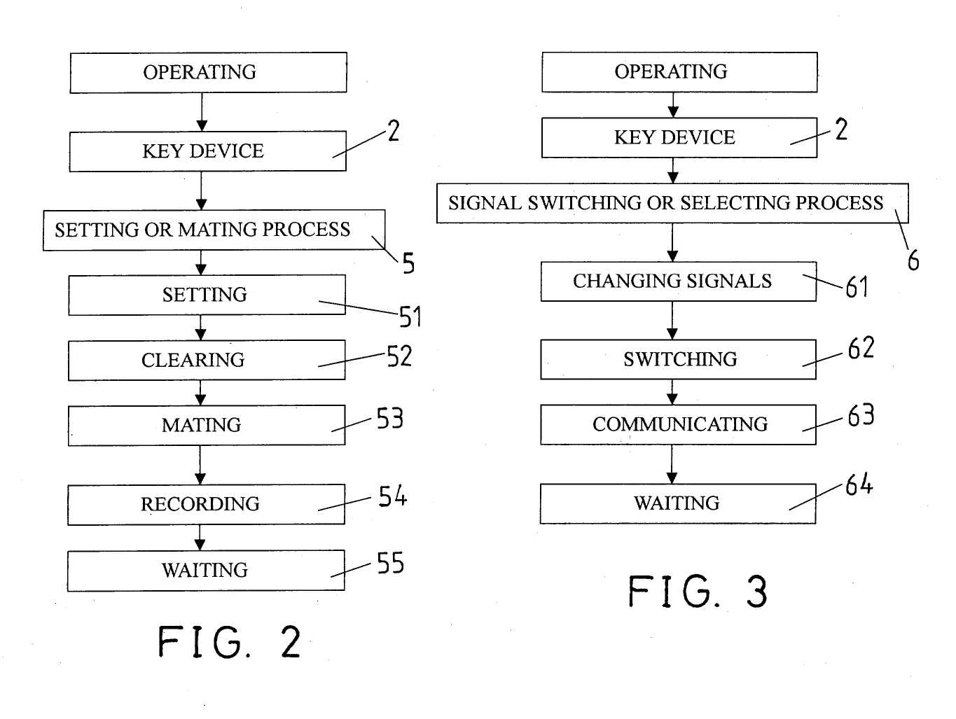

As shown in FIG. 2, illustrated are the processes or elements or members to couple or communicate the processor device 11 of the control facility 1 of the blue tooth earphone device in accordance with the present invention with the other blue tooth earphone devices or the other blue tooth phone devices.

In operation, one of the keys 21-24, such as the key 21 of the key device 2 may be depressed for such as five (5) seconds, in order to control or actuate the processor device 11 of the control facility 1 into a setting or mating process 5 in order to conduct or operate the setting operation or procedure 51 to the processor device 11 of the control facility 1.

The processor device 11 of the control facility 1 may then be controlled or actuated into a clearing operation or procedure 52 by further depressing or actuating the key 21 of the other keys 22-24, or simply wait until one or more sounds or rings, such as two long sounds are generated by such as the sound generating device 18. In the clearing procedure 52, the previously set or stored data or information of the other blue tooth earphone devices or the other blue tooth phone devices in such as the processor device 11 of the control facility 1 may be cleared by the resetting device 15.

After the data or information in the processor device 11 of the control facility 1 has been cleared by the resetting device 15, the processor device 11 of the control facility 1 may then be entered into a mating procedure 53, and may actuate the signal display device 14 to operate the light device 4, in order to generate flash lights, for example, and to indicate that the processor device 11 of the control facility 1 is in the mating procedure 53.

In the mating procedure 53, the processor device 11 of the control facility 1 may actuate the mating device 16 to mate or to set the codes or signals or frequencies of any other blue tooth earphone devices or blue tooth phone devices, and may further actuate the'signal display device 14 to stop the light device 4, and to indicate that the mating procedure 53 of the processor device 11 of the control facility 1 has been completed or terminated.

The processor device 11 of the control facility 1 may then be entered into a recording procedure 54, and may actuate the setting device 12 to record or set or store the codes or frequencies or signals of the selected blue tooth earphone devices or blue tooth phone devices, and may then be entered into a waiting procedure 55.

Before entering into the waiting procedure 55, either of the keys 21-24, such as the other key 22, may further be used or depressed or actuated to repeat the setting or mating process 5, in order to record or set or store the other or additional codes or frequencies or signals of the other selected blue tooth earphone devices or blue tooth phone devices, for allowing the processor device 11 of the control facility 1 to dial or to communicate with the set or recorded or stored and selected blue tooth earphone devices or blue tooth phone devices easily later.

Referring next to FIG. 3, illustrated are the processes or elements or members to couple or communicate the processor device 11 of the control facility 1 of the blue tooth earphone device in accordance with the present invention with the either of the set or recorded or stored and selected blue tooth earphone devices or blue tooth phone devices.

In operation, while the blue tooth earphone device in accordance with the present invention is in the operating mode or status or procedure, one of the keys 21-24, such as the key 21 or the key 22 of the key device 2 may be depressed for such as one (1) second, in order to control or actuate the processor device 11 of the control facility 1 into a signal switching or selecting process 6 in order to conduct or operate a changing signal procedure 61 to the processor device 11 of the control facility 1.

The processor device 11 of the control facility 1 may then be controlled or actuated into a switching operation or procedure 62 by further depressing or actuating either of the other keys 21-24, or simply wait until one or more sounds or rings, such as one long sound is generated by such as the sound generating device 18. In the switching procedure 62, the setting device 12 may be actuated by the processor device 11 of the control facility 1 in order to cut or terminate the previously connected or communicated or coupled blue tooth earphone devices or blue tooth phone devices, and to enter into a readily communicating operation or procedure 63.

In the readily communicating procedure 63, the mating device 16 and/or the wireless signal communicating device 17 may be actuated by the processor device 11 of the control facility 1, to mate or set or send the codes or signals or frequencies of the newly selected blue tooth earphone devices or blue tooth phone devices into the processor device 11 of the control facility 1, for allowing the blue tooth earphone device in accordance with the present invention to readily couple or connect to the newly selected blue tooth earphone devices or blue tooth phone devices when required.

The processor device 11 of the control facility 1 may then be entered into another waiting procedure 64, after the codes or signals or frequencies of the newly selected blue tooth earphone devices or blue tooth phone devices has been selected or set or stored or recorded in the processor device 11 of the control facility 1.

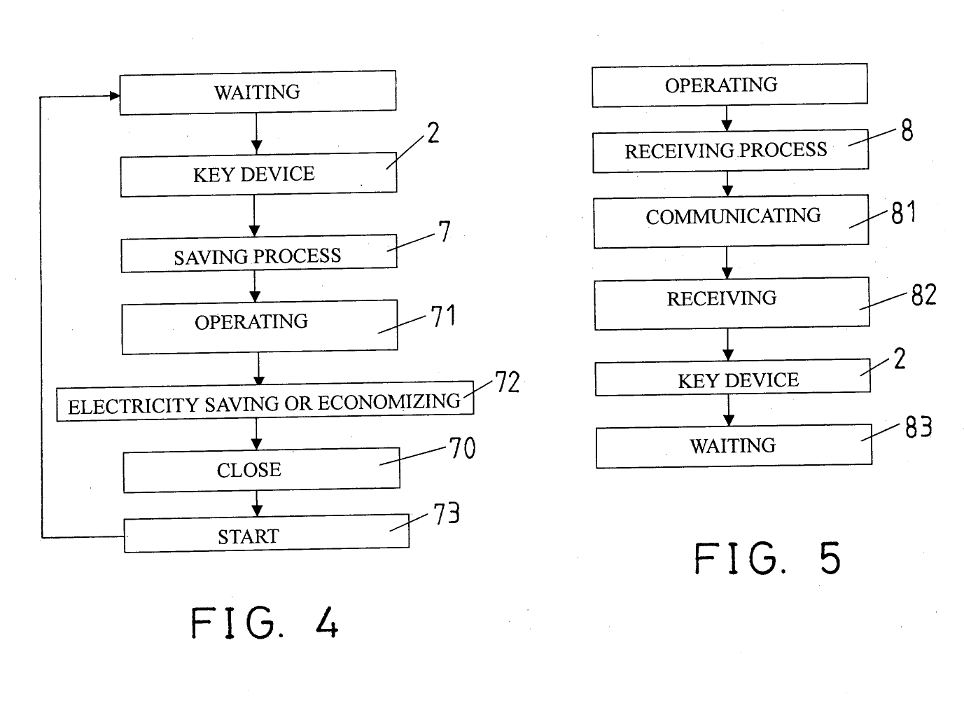

Referring next to FIG. 4, illustrated are the processes or elements or members to save or economize the electrical energy of the processor device 11 of the control facility 1 of the blue tooth earphone device in accordance with the present invention, when the processor device 11 of the control facility 1 is in the waiting operation or procedure 55, 64 in such as those shown in FIGS. 2 and 3.

In operation, one of the keys 21-24, such as the key 23 of the key device 2 may be depressed for such as five (5) seconds, in order to control or actuate the processor device 11 of the control facility 1 into an electrical energy saving or economizing process 7 in order to conduct or operate an operating procedure 71 to the processor device 11 of the control facility 1.

The processor device 11 of the control facility 1 may then be controlled or actuated into an electricity saving or economizing operation or procedure 72 by further depressing or actuating either of the other keys 21-24, or simply wait until one or more sounds or rings, such as one long sound is generated by such as the sound generating device 18.

In the electricity saving or economizing procedure 72, the electricity economizing or saving device 13 may be actuated by the processor device 11 of the control facility 1 in order to cut or close the processor device 11 of the control facility 1 of the blue tooth earphone device in accordance with the present invention in a closing procedure 70, in order to stop supplying the electrical energy to the non-working elements or members of the control facility 1.

When either of the other keys 21-24, such as the key 23 of the key device 2 is further depressed for such as one (1) second, a starting operation or procedure 73 of the processor device 11 of the control facility 1 may then be operated or conducted or actuated. In the starting procedure 73, the mating device 16 and/or the wireless signal communicating device 17 may be actuated by the processor device 11 of the control facility 1, in order to restore or set the codes or signals or frequencies of the blue tooth earphone devices or blue tooth phone devices that have been previously connected or communicated or coupled before the electricity saving or economizing procedure 72, and thus for allowing the users to easily and quickly and readily dial or couple or connect to the selected blue tooth earphone devices or blue tooth phone devices.

Referring next to FIG. 5, illustrated are the processes or elements or members to receive phones, when the processor device 11 of the control facility 1 is in the operating procedure.

In operation, when a phone call is incoming, for example, when the sound generating device 18 is actuated by the processor device 11 of the control facility 1 to generated sounds or rings, the processor device 11 of the control facility 1 may be automatically actuated or operated into a phone receiving process 8, and then to conduct or operate a phone coupling or communicating procedure 81.

In the phone coupling or communicating procedure 81, the wireless signal communicating device 17 may be actuated by the processor device 11 of the control facility 1, in order to accept or to receive the incoming phones, and the processor device 11 of the control facility 1 may then be controlled or actuated or switched into a phone receiving operation or procedure 82.

In the phone receiving operation or procedure 82, the key 23 of the key device 2 may be depressed for such as one (1) second, in order to receive the incoming phone. The processor device 11 of the control facility 1 may then be entered into another waiting procedure 83 after the phone has been received.

In operation, the processor device 11 of the control facility 1 may be operated or actuated to store one or more sets of codes or frequencies or signals of the selected blue tooth earphone devices or blue tooth phone devices to be dialed or communicated or coupled, in the processes as shown in FIG. 2.

The processor device 11 of the control facility 1 may then be actuated or switched to change to the newly selected code or frequency or signal of the selected blue tooth earphone device or blue tooth phone device, in the processes as shown in FIG. 3.

The processor device 11 of the control facility 1 of the blue tooth earphone device in accordance with the present invention may then be actuated or operated to receive the phones from the selected blue tooth earphone device or blue tooth phone device that include the newly selected code or frequency or signal stored therein, in the processes as shown in FIG. 5.

The processor device 11 of the control facility 1 of the blue tooth earphone device in accordance with the present invention may also be actuated or operated to save or economize the electrical energy when the processor device 11 of the control facility 1 of the blue tooth earphone device in accordance with the present invention is not in use or in a non-working mode, or in a waiting procedure, in the processes as shown in FIG. 4.

Accordingly, the earphone device in accordance with the present invention is changeable or switchable to different codes or signals in order to receive phones from various selected or different phone devices or systems that have different codes or signals or frequencies, etc.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. An earphone device comprising:
a) a control facility including:
i) a processor device,
ii) a setting device coupled to said processor device, to set selected codes,
iii) a mating device coupled to said processor device, to select either of the set codes,
iv) a wireless signal communicating device coupled to said processor device, for wireless communicating purposes,
b) a key device coupled to said processor device of said control facility, to control said processor device of said control facility, and
c) a blue tooth device coupled to said wireless signal communicating device of said control facility, to wireless communicate said processor device of said control facility to other blue tooth facilities.

2. The earphone device as claimed in claim 1, wherein said control facility further includes an electricity economizing device coupled to said processor device thereof, to economize electric energy supplied to said control facility.

3. The earphone device as claimed in claim 1, wherein said control facility further includes a signal display device coupled to said processor device thereof, to generate signals.

4. The earphone device as claimed in claim 3 further comprising a light device coupled to said signal display device of said control facility further, to generate light signals.

5. The earphone device as claimed in claim 1, wherein said control facility further includes a sound generating device coupled to said processor device thereof, to generate sound signals.

6. The earphone device as claimed in claim 1, wherein said control facility further includes a resetting device coupled to said processor device thereof, to reset said processor device of said control facility.

7. The earphone device as claimed in claim 1, wherein said key device includes a key to increase volume of said earphone device.

8. The earphone device as claimed in claim 1, wherein said key device includes a key to decrease volume of said earphone device.

9. The earphone device as claimed in claim 1, wherein said key device includes a key to generate a phone receiving signal.

10. The earphone device as claimed in claim 1, wherein said key device includes a key to generate a resetting signal.
